(19) United States
(12) Patent Application Publication
(10) Pub. No.: US 2025/0245673 A1
(43) Pub. Date: Jul. 31, 2025

(54) SYSTEM AND METHOD FOR CONTROLLING CUSTOMER RETENTION

(71) Applicant: Walmart Apollo, LLC, Bentonville, AR (US)

(72) Inventors: Chia-Yen Ho, Cupertino, CA (US); Faezeh Akhavizadegan, Mountain View, CA (US); Lawrence David Lin, San Francisco, CA (US); Yokila Arora, San Jose, CA (US); Topojoy Biswas, Pleasanton, CA (US); Saurabh Kumar, Fremont, CA (US); Amogh Raghavendra Rao, San Jose, CA (US); Malay Kumar Patel, Fremont, CA (US); Sushant Kumar, San Jose, CA (US); Kannan Achan, Saratoga, CA (US)

(21) Appl. No.: 18/428,578

(22) Filed: Jan. 31, 2024

(51) Int. Cl. G06Q 30/016; G06Q 10/0637; G06Q 30/0207

(52) U.S. Cl. CPC G06Q 30/016; G06Q 10/0637; G06Q 30/0207

(57) ABSTRACT

System and methods for controlling customer retention are disclosed. In some embodiments, a disclosed method includes: storing historical customer data and order data associated with a customer of a retailer within a database, receiving the order data within a time period, the order data including a plurality of orders, parsing the order data to determine an order status for each of the plurality of orders, identifying a negative order from the order data based on the order status, the negative order associated with the customer, generating, in real-time, appeasement data for the negative order, the appeasement data being associated based on the historical customer data, and transmitting, in real-time, the appeasement data to an electronic device having a user interface for display of an appeasement offer associated with the appeasement data to the customer.

### TECHNICAL FIELD

This application relates generally to managing customers and, more particularly, to systems and methods for controlling customer retention.

### BACKGROUND

Retailers are consistently looking for methods for controlling and managing customer retention. Customers may become unhappy and no longer shop at the retailer. Customers may face poor experience due to unforeseen situations such as cancelled orders, delayed orders, or missing items in orders. Customers are more likely to churn when they are dissatisfied with the service. Retailers wish to keep customers happy through appeasement methodologies.

Current methods of controlling customer retention and implementing appeasements require a rule-based approach to make appeasement offers to customers. However, this may be time-consuming and/or unnecessarily increase budgets. Further, each customer's situation may need to be reviewed individually. In some instances, a customer may be unhappy if they receive the same appeasement for different poor experiences. Current methods may also require individual review of each appeasement offering resulting in an expensive and tedious process.

### SUMMARY

The embodiments described herein are directed to systems and methods for controlling customer retention. In various embodiments, a system including a database storing historical customer data and order data associated with a customer of a retailer, and a computing device comprising at least one processor in communication with the database, the computing device being configured to receive the order data within a time period, the order data including a plurality of orders, parse the order data to determine an order status for each of the plurality of orders, identify a negative order from the order data based on the order status, the negative order associated with the customer, generate, in real-time, appeasement data for the negative order, the appeasement data being associated based on the historical customer data, and transmit, in real-time, the appeasement data to an electronic device having a user interface for display of an appeasement offer associated with the appeasement data to the customer.

In some embodiments, the computing device is further configured to: generate, based on the historical customer data, a user appeased score, generate, based on the order data, an order score, combine the user appeased score and the order score to generate an order appeased score, compare the order appeased score to one or more thresholds to generate a comparison, generate an award affinity score based on the comparison, the award affinity score being associated with an affinity of the customer towards an appeasement type, and generate, based on the appeasement type, one or more appeasements to be offered to the customer. One or more weights are applied to the order score.

In some embodiments, wherein the computing device is further configured to compare the appeasement data to one or more thresholds to generate a threshold comparison.

In some embodiments, the computing device is further configured to: based on the threshold comparison, modify the appeasement data to generate subsequent appeasement data and compare the subsequent appeasement data to one or more thresholds to generate a subsequent threshold comparison.

In some embodiments, the computing device is further configured to microbatch the plurality of orders within the time period.

In some embodiments, the computing device is further configured to: train one or more models to generate the appeasement data based on the order data and the historical customer data, receive redemption data associated with the customer redeeming the appeasement offer associated with the appeasement data, and refine the one or more models based on the redemption data.

In some embodiments, the computing device is further configured to, in response to identification of the negative order, generate in real-time, on the user interface of the electronic device, an interactive appeasement display.

In some embodiments, the computing device is further configured to in response to identification of the negative order, automatically generate and transmit an electronic correspondence to the electronic device of the customer.

In some embodiments, the order data is received concurrently from a plurality of sources.

In various embodiments, a computer-implemented method is disclosed. The computer-implemented method includes storing historical customer data and order data associated with a customer of a retailer within a database, receiving the order data within a time period, the order data including a plurality of orders, parsing the order data to determine an order status for each of the plurality of orders, identifying a negative order from the order data based on the order status, the negative order associated with the customer, generating, in real-time, appeasement data for the negative order, the appeasement data being associated based on the historical customer data, and transmitting, in real-time, the appeasement data to an electronic device having a user interface for display of an appeasement offer associated with the appeasement data to the customer.

In some embodiments, the method further includes generating, based on the historical customer data, a user appeased score, generating, based on the order data, an order score, combining the user appeased score and the order score to generate an order appeased score, comparing the order appeased score to one or more thresholds to generate a comparison, generating an award affinity score based on the comparison, the award affinity score being associated with an affinity of the customer towards an appeasement type, and generating, based on the appeasement type, one or more appeasements to be offered to the customer. One or more weights are applied to the order score.

In some embodiments, the method further includes comparing the appeasement data to one or more thresholds to generate a threshold comparison.

In some embodiments, the method further includes based on the threshold comparison, modifying the appeasement data to generate subsequent appeasement data, and comparing the subsequent appeasement data to one or more thresholds to generate a subsequent threshold comparison.

In some embodiments, the method further includes microbatching the plurality of orders within the time period.

In some embodiments, the method further includes training one or more models to generate the appeasement data based on the order data and the historical customer data, receiving redemption data associated with the customer redeeming the appeasement offer associated with the appeasement data, and refining the one or more models based on the redemption data.

In some embodiments, the method further includes in response to identification of the negative order, generating in real-time, on the user interface of the electronic device, an interactive appeasement display.

In some embodiments, the method further includes in response to identification of the negative order, automatically generating and transmitting an electronic correspondence to the electronic device of the customer.

In various embodiments, a non-transitory computer readable medium having instructions stored thereon is disclosed. The instructions, when executed by at least one processor, cause at least one device to perform operations including: storing historical customer data and order data associated with a customer of a retailer within a database, receiving the order data within a time period, the order data including a plurality of orders, parsing the order data to determine an order status for each of the plurality of orders, identifying a negative order from the order data based on the order status, the negative order associated with the customer, generating, in real-time, appeasement data for the negative order, the appeasement data being associated based on the historical customer data, and transmitting, in real-time, the appeasement data to an electronic device having a user interface for display of an appeasement offer associated with the appeasement data to the customer.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to control customer retention, in accordance with some embodiments of the present teaching.

FIG. 2 is a block diagram of an appeasement engine, in accordance with some embodiments of the present teaching.

FIG. 3 is a flow diagram of a system for controlling customer retention, in accordance with some embodiments of the present teaching.

FIG. 4 is a flow diagram of generating an appeasement, in accordance with some embodiments of the present teaching.

FIG. 5 is a flowchart illustrating an exemplary method for controlling customer retention, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

The present disclosure provides systems and methods for controlling customer retention. In some embodiments, the systems and methods utilize models (e.g., machine learning models) to generate real-time appeasements for a customer how has had a poor experience. The systems and methods provided herein may be configured to identify poor experiences associated with the user. In some embodiments, the systems and methods provided herein may be used to create a differentiated appeasement experience for each customer by predicting appeasement preferences based on the customer's prior experiences. For example, the systems and method provided herein may determine what appeasement a specific customer prefers and offer that appeasement in real-time (e.g., with a few seconds of detecting that the customer has received a poor experience).

One goal of the present teaching is to generate, in real-time, a specific appeasement for a customer having a poor experience. In some embodiments, a disclosed system utilizes one or more models to predict who to appease and how to appease. The system can generate a specific appeasement per customer based on each customer's journey (e.g., prior experience).

In some embodiments, the system includes a fraud prevention engine configured to detect fraud. For example, a customer may purposefully cause themselves to have poor experiences and thus receive appeasements. The systems and methods provided herein may detect when a customer is abusing the system by implementing thresholds and safeguards as discussed below.

In some embodiments, the system includes one or more communication engines for transmitting an appeasement to the customer. The system may be configured to transmit the appeasement to the customer in a plurality of communication methods in real-time. In real-time may be within a small duration of time, such as sub-second. The system may be configured to transmit the appeasement to the customer in a plurality of different communication methods simultaneously upon detection of the customer's poor experience (e.g., upon detecting a cancelled or delayed order).

In some embodiments, the system is configured to receive customer experience data associated with a customer's poor experience. For example, the system may receive customer experience data from a specific customer indicating that the customer has had an order cancelled or delayed. In some embodiments, the system receives customer experience data from a plurality of sources and is configured to micro-batch the customer experience data from the plurality of sources. For example, the system may include one or more sources communicating with the system via concurrent data structures resulting in the system receiving the same information (e.g., customer experience data) multiple times. The system may be configured to micro-batch the customer experience data received concurrently from the plurality of sources to ensure that multiple appeasements are not offered to the same customer for the same poor experience.

Furthermore, in the following, various embodiments are described with respect to methods and systems for controlling customer retention. In some embodiments, a disclosed method includes: storing historical customer data and order data associated with a customer of a retailer within a database, receiving the order data within a time period, the order data including a plurality of orders, parsing the order data to determine an order status for each of the plurality of orders, identifying a negative order from the order data based on the order status, the negative order associated with the customer, generating, in real-time, appeasement data for the negative order, the appeasement data being associated based on the historical customer data, and transmitting, in real-time, the appeasement data to an electronic device having a user interface for display of an appeasement offer associated with the appeasement data to the customer.

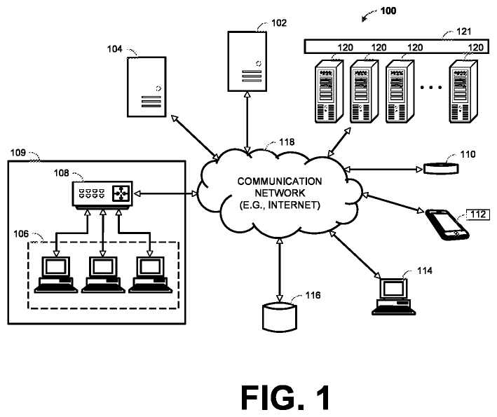

Turning to the drawings, FIG. 1 is a network environment 100 configured to control customer retention, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, appeasement engine 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The appeasement engine 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the appeasement engine 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the appeasement engine 102.

In some examples, each of the multiple user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more retailer websites providing one or more products or services. In some examples, the appeasement engine 102, the processing devices 120, and/or the web server 104 are operated by a retailer. The multiple user computing devices 110, 112, 114 may be operated by customers. The customers may be accessing a retailer's website(s). In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109 of a retailer, for example. The workstation(s) 106 can communicate with the appeasement engine 102 over the communication network 118. The workstation(s) 106 may send data to, and receive data from, the appeasement engine 102. For example, the workstation(s) 106 may transmit data identifying items purchased by a customer at the store 109 to the appeasement engine 102.

Although FIG. 1 illustrates three user computing devices 110, 112, 114, the network environment 100 can include any number of user computing devices 110, 112, 114. Similarly, the network environment 100 can include any number of the appeasement engine 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the web server 104 over the communication network 118. For example, each of the multiple computing devices 110, 112, 114 may be operable to view, access, and interact with a website, such as a retailer's website hosted by the web server 104. The web server 104 may transmit user session data related to a customer's activity (e.g., interactions) on the website.

In some examples, a customer may operate one of the user computing devices 110, 112, 114 to initiate a web browser that is directed to the website hosted by the web server 104. The customer may, via the web browser, view a user interface for viewing and interacting with an e-commerce platform of the retailer. The website may capture these activities as user session data, and transmit the user session data to the appeasement engine 102 over the communication network 118. The website, via the user interface, may also allow the user to view the appeasement generated by appeasement engine 102. In some examples, the web server 104 transmits user data to the appeasement engine 102. The user data may include data associated with the user's interaction with the website via the user interface.

In some examples, a user (e.g., a retailer) may use one of the user computing devices 110, 112, 114 to view or interact with appeasements generated and offered to the customer. The user may use a user interface to view and interact with one or more offered appeasements via web server 104. The user may, via the web browser or the user interface, view and interact with the offered appeasements. The website may capture at least some of these activities as user data. The web server 104 may transmit the user data to the appeasement engine 102 over the communication network 118, and/or store the user data to the database 116.

In some examples, the appeasement engine 102 may execute one or more models (e.g., algorithms), such as a mathematical models, machine learning model, deep learning model, statistical model, etc., to determine and generate specific appeasements for a specific customer. The appeasement engine 102 may generate appeasements based on an output of one or more models. For example, the appeasement engine 102 may utilize one or more models to determine an appeasement specific for a customer and may generate the appeasement determined by the one or more models. In some embodiments, multiple models are executed by the appeasement engine 102 to determine and generate appeasements. For example, the appeasement engine 102 may execute a first model to determine whether a customer has had a poor experience and may execute a second model to determine an appeasement preferred by the customer. Appeasement engine 102 may input the customer's historical data into the one or more models to identify one or more appeasements that would be preferred by the customer. In some embodiments, appeasement engine 102 utilizes one or more models to determine whether an appeasement should be offered to a customer based on the customer's experience (e.g., poor experience). For example, appeasement engine 102 may input the customer's historical data into one or more models and determine that not offering an appeasement to the customer would not change the satisfaction of the customer resulting in the customer staying with the retailer regardless.

The appeasement engine 102 is further operable to communicate with the database 116 over the communication network 118. For example, the appeasement engine 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the appeasement engine 102, in some examples, the database 116 can be a local storage device, such as a hard drive, a non-volatile memory, or a USB stick. The appeasement engine 102 may store historical data, business metrics, user data, or data associated with one or more products received from the web server 104 in the database 116. In some embodiments, the business metrics include historical data associated with the one or more products. The appeasement engine 102 may also receive from the web server 104 user session data identifying events associated with browsing sessions, and may store the user session data in the database 116. Database 116 may be coupled to a computing device. For example, database 116 may be coupled to one or more user computing devices 110, 112, 114 via communication network 118.

In some embodiments, the web server 104 transmits a model training request to the appeasement engine 102. Upon the model training request, the appeasement engine 102 may retrieve, e.g. from the database 116, historical data associated with a customer (e.g., the customer's experience). The appeasement engine 102 may train one or more models using the historical data of the customer. The one or more models may be trained to identify appeasements preferred by the customer. The one or more models may be trained to identify various appeasements preferred by a customer based on their prior experience and/or the negative experience they have received. In some embodiments, the outputs from the model may be used to refine and train the model. One or more models may be refined using historical data (e.g., past performance of an appeasement) and may generate appeasements based on poor experiences. For example, one or more models may be trained using training historical data and may generate an appeasement based on a customer's poor experience. Appeasement engine 102 may receive an indication that the generated appeasement appeased the customer. Appeasement engine 102 may then modify the training historical data to create a relationship that the generated appeasement resulted in an appeased customer thereby refining the one or more models.

In some embodiments, the generated appeasement may be associated with a first value and compared to an actual appeasement, associated with a second value, which appeased a customer. The first value may be compared to the second value to generate a comparison value. The comparison value may be inputted into the one or more models to refine the one or more models to make the one or more models more accurate.

The models, when executed by the appeasement engine 102, allow the appeasement engine 102 to generate appeasements to address a customer's poor experience (e.g., based on receive customer experience data) and prevent the customer from churning or leaving a program associated with the retailer. In some examples, the appeasement engine 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the appeasement engine 102 may generate appeasements associated with a customer having a poor experience. The appeasement engine 102 may provide, via a user interface, the appeasements for the customer to interact with.

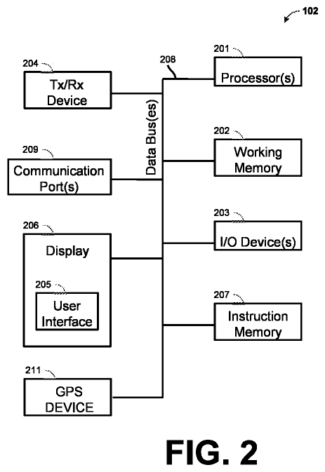

FIG. 2 illustrates a block diagram of an appeasement engine, e.g. the appeasement engine 102 of FIG. 1, in accordance with some embodiments of the present teaching. In some embodiments, each of the appeasement engine 102, the web server 104, the multiple user computing devices 110, 112, 114, and the one or more processing devices 120 in FIG. 1 may include the features shown in FIG. 2. Although FIG. 2 is described with respect to certain components shown therein, it will be appreciated that the elements of the appeasement engine 102 can be combined, omitted, and/or replicated. In addition, it will be appreciated that additional elements other than those illustrated in FIG. 2 can be added to the appeasement engine 102.

As shown in FIG. 2, the appeasement engine 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the appeasement engine 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the appeasement engine 102 can include a single memory unit configured to operate as both instruction memory and working memory. Further, although embodiments are discussed herein including non-volatile memory, it will be appreciated that computing device 110, 112, 114 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C #, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the appeasement engine 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the appeasement engine 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the appeasement engine 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the appeasement engine 102 and/or the web server 104. For example, the user interface 205 can be a user interface for an application of a network environment operator that allows a customer to view and interact with appeasements generated by the appeasement engine 102. In some embodiments, a customer can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the appeasement engine 102 may determine a local geographical area (e.g., town, city, state, etc.) of its position.

In some embodiments, the appeasement engine 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

The network environment 100 further includes one or more model training systems that are communicatively coupled with at least one or more model database maintaining trained models and one or more training data databases (e.g., database 116) that stores relevant training data to train and/or retrain the one or more models used by the appeasement engine 102. The model training system includes one or more model training servers or managers, which are implemented through one or more computing systems, servers, computers, processor and/or other such systems communicatively coupled with one or more of the distributed communication networks 118, and are configured to build and/or train the machine learning models. In some implementations, the model training system includes multiple sub-model training systems each associated with one or more of the different machine learning models.

The training data database stores and updates relevant training data. The training data includes historic data of recipients and their association with known companies, predefined profiles of types of recipients, predefined profiles of known preferences of information, predefined associations of responsibilities to types of recipients and other such information. Further, the training data includes historical data associated with the customer (e.g., the customers prior history of engaging with an e-commerce platform of a retailer), typically for one or more years. The training data additionally includes historic information about different information supplied to and/or accessed by different customers via the e-commerce platform. This may include interactions that each customer has had with the e-commerce platform and/or representatives of the retailer. In some embodiments, the training data includes—membership data (e.g., length of membership, age of membership, renewal date of customer, type of membership annual or trial, membership activity), churn propensity data, customer engagement and customer interaction data (e.g., clicking or adding to cart,), benefits used by the customer, transaction history and order data, persona of customer, demographics, customer service dataset, customer experience dataset, and/or operational defects associated with the order.

The training data databases (e.g., database 116) can be local to the model training system, remote and accessible over one or more of the communication networks 118 or a combination of local and distributed. The model training system uses the relevant machine learning data to train the machine learning models. In some embodiments, one or more training processes are similar to the process performed by one or more models after having been trained, but can be trained with multiple sets of training data (e.g., some real and some simulated or synthetic for training). Predictions are compared to actuals to ensure that the set of models are operating with a certain threshold confidence. Further, the model training system is configured to receive feedback information (e.g., information associated with a customer receiving an appeasement) and may refine the one or more models used by appeasement engine 102 based on the feedback information.

The above and below description includes descriptions of embodiments implementing and/or utilizing trained machine learning models and/or neural networks. In some embodiments, the neural network, machine learning models and/or machine learning algorithms may include, but are not limited to, Heuristics, Univariate based techniques, Multivariate, control limit, isolation forest and LOF—ensembles, deep learning models such as LSTM-based autoencoders, variational autoencoders, deep stacking networks (DSN), Tensor deep stacking networks, convolutional neural network, probabilistic neural network, autoencoder or Diabolo network, linear regression, support vector machine, Naïve Bayes, logistic regression, K-Nearest Neighbors (kNN), decision trees, random forest, gradient boosted decision trees (GBDT), K-Means Clustering, hierarchical clustering, DBSCAN clustering, principal component analysis (PCA), and/or other such models, networks and/or algorithms.

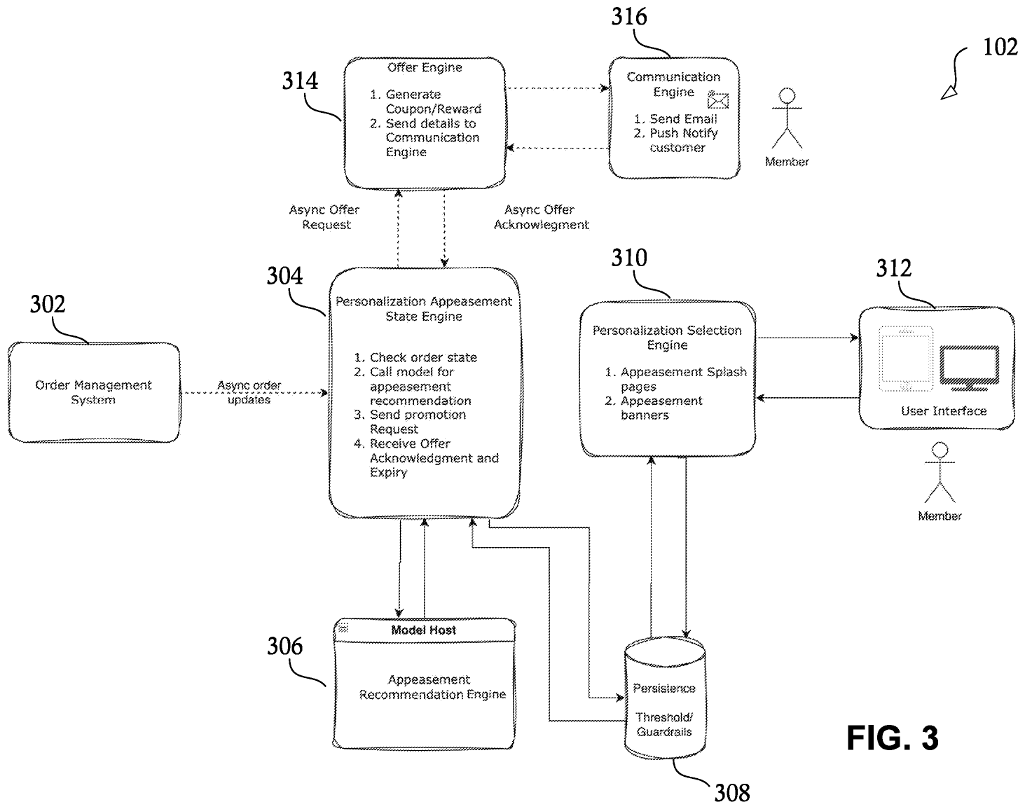

FIG. 3 is a flow diagram of appeasement engine 102, in accordance with some embodiments of the present teaching. As illustrated in FIG. 3, appeasement engine 102 may include order management system (OMS) 302, personalization appeasement system (PAS) engine (“PAS”) 304, appeasement recommendation engine (ARE) or model host 306, persistence module 308, personalization selection (PS) engine (“PSE”) 310, electronic device 312 (e.g., computing device 112), offer engine 314, and communication engine 316. In some embodiments, appeasement engine 102 is configured to receive and transmit information in real-time. Real-time may be under one second from determination of a customer having a poor experience.

In some embodiments, OMS 302 is configured to manage and process orders associated with customers. For example, for each customer that places an order through an e-commerce platform, each order may be processed and managed by OMS 302. In some embodiments, OMS 302 is configured to receive order data associated with a customer (e.g., customer ID). OMS 302 may include a plurality of data sources each receiving order data associated with a customer. In some embodiments, OMS 302 is a plurality of sources that receive order data pertaining to the same order within a time period. For example, OMS 302 may include first data source, second data source, and third data source. Each of first data source, second data source, and third data source may receive order data associated with the same order of the customer at different times. For example, first data source may receive the order data first, followed by second data source, and then third data source. In some embodiments, first data source, second data source, and third data source receive order data via different channels and/or methods. Upon receipt of the order data, OMS 302 may be configured transmit the order data to PAS 304.

Due to OMS 302 receiving order data from a plurality of different data sources, OMS 302 may transmit the order data multiple times to PAS 304. For example, OMS 302 may receive the same order data (e.g., first order data pertaining to a first order) concurrently from different data streams. In some embodiments, OMS 302 transmits the order data containing the same order data multiple times to PAS 304. For example, OMS 302 may receive first order data associated with a first order from a plurality of sources. In other words, OMS 302 may receive the same order associated with the same customer ID from a plurality of sources within a certain time period. The time period may be less than one second, less than two seconds, less than three seconds, less than four seconds, less than five seconds, or less than ten seconds. OMS 302 may transmit order data to PAS 304 upon receipt of the order data. In some embodiments, OMS 302 transmits the order data to PAS 304 multiple times due to receiving order data from multiple data sources.

In some embodiments, PAS 304 receives first order data pertaining to the same order and customer ID (e.g., first order) multiple times from OMS 302. For example, PAS 304 may concurrently receive multiple transmissions of first order data associated with the first order of the same customer. To prevent appeasement engine 102 from generating an appeasement each time first order data is received, PAS 304 may be configured to microbatch first order data. For example, PAS 304 may microbatch the first order data received within a predetermined amount of time. PAS 304 may be configured to microbatch order data associated with the same customer ID that is received in a small duration (e.g., 20 milliseconds). However, PAS 304 may be configured to microbatch order data associated with the same customer ID that is received in under 50 milliseconds, under one second, under three seconds, under five seconds, or under ten seconds. PAS 304 microbatching order data associated with the same customer ID may prevent appeasement engine 102 from offering multiple appeasements to the same customer for the same order disruption (e.g., cancelled order or delayed order).

PAS 304 may be configured to check order status based on order data. For example, PAS 304 may receive order data from OMS 302 and may parse order data to extract the order status of one or more orders associated with the order data. The order status may include cancelled orders, delayed orders, substitute orders, orders that have delivery issues, or orders that have been refunded. In some embodiments, each order parse within the order status receives a positive indication associated with a positive experience of the customer or a negative indication associated with a negative experience of the customer. For example, orders having a positive indication for the order status may be assigned a value of 1 and orders having a negative indication for the order status may be assigned a value of 0. PAS 304 may extract, from the order data, orders that have an order status associated with the negative indication, which is indicative of a poor experience (e.g., cancelled order, delayed order, substituted order, order with delivery issues, order refunded, etc.).

In some embodiments, PAS 304 submits a request to ARE 306 for an appeasement offer. PAS 304 may receive appeasement offer data associated with the appeasement offer and transmit the received appeasement offer data to persistence module 308 to check if the appeasement offer is valid (e.g., not expired and within thresholds). In some embodiments, upon the appeasement offer being transmitted to the customer, PAS 304 receives an indication that the customer has received the appeasement offer. PAS 304 may be configured to receive an indication that the customer has redeemed the appeasement offer generated by ARE 306. In some embodiments, appeasement engine 102 is configured to refine the one or more models utilized based on the indication that the customer redeemed the appeasement offer. This allows the one or more models to refine the accuracy of the generated appeasement offer for that customer to allow the one or more models to increase their accuracy for subsequent generation of appeasement offers for that customer.

In some embodiments, PAS 304 is in communication with ARE 306. ARE 306 may be configured to microbatch. In some embodiments, ARE 306 microbatches order data instead of PAS 304. In alternative embodiments, ARE 306 and PAS 304 both microbatch order data. PAS 304 may be configured to make sequential calls to ARE 306 for the same customer (e.g., same customer ID) to ensure that the order data being received is associated with the same customer prior to offering an appeasement to the customer. ARE 306 may be configured to generate an appeasement based on the order data.

In some embodiments, ARE 306 also receives customer data associated with the customer that the order data pertains to. In some embodiments, OMS 302 is configured to map or link the customer data to the order data based on the customer ID to generate an order package and transmit the order package to ARE 306 via PAS 304. Based on the customer data, ARE 306 may be configured to generate an appeasement specific to the customer data and the order data. For example, ARE 306 may analyze the customer data and the order data to generate an appeasement (e.g., appeasement offer or appeasement offer data) that is sufficient to satisfy the specific customer based the specific order experience. In some embodiments, ARE 306 receives the customer data and determines an appeasement that is specific to the customer and that the customer would be satisfied with based on their poor experience. ARE 306 may generate the appeasement offer and transmit the appeasement offer to PAS 304.

In some embodiments, PAS 304 is in communication with persistence module 308. Persistence module 308 may be configured to implement thresholds and guardrails to prevent abuse of appeasement engine 102. In some embodiments, persistence module 308 is configured to compare the order data to historical order data to generate an order comparison. The order comparison may include a number of orders with poor experiences associated with the customer within a predetermine amount of time. For example, the order comparison may indicate that the customer has had two or more poor order experiences (e.g., order delays, order cancellations, wrong order) in a predetermined amount of time (e.g., a week). Persistence module 308 may transmit the order comparison to PAS 304 and PAS 304 may flag the customer's account (e.g., via the customer ID). This is to prevent the customer from abusing appeasement engine 102 and receiving a plurality of appeasement offers. For example, the customer may purposefully cause order issues (e.g., delays and/or cancellations) that would prompt appeasement engine 102 to offer an appeasement if not for persistence module 308.

In some embodiments, persistence module 308 includes one or more thresholds associated with the appeasement being offered to the customer. For example, ARE 306 may generate an appeasement offer and transmit the appeasement offer to PAS 304. PAS 304 may transmit the appeasement offer to persistence module 308 to compare the appeasement offer to one or more thresholds and/or safeguards. One or more thresholds may include time based thresholds, budget based thresholds, product/order based thresholds, or other types of thresholds. For example, persistence module 308 may compare the appeasement offer to, for example, a budget threshold and determine that the appeasement offer is above the budget threshold.

Persistence module 308 may transmit the error to PAS 304, which may submit a request to ARE 306 for a different appeasement. The time based threshold may indicate that the customer has received too many appeasement offers (e.g., greater than a predetermine amount of offers) within a predetermined amount of time and may prevent an offering of the appeasement to the customer and provide an error or warning regarding the threshold. For example, appeasement engine 102 may be configured to generate and transmit an appeasement to a customer within a frequency threshold (e.g., once per month). In some embodiments, ARE 306 generates an appeasement associated with a specific product/service and persistence module 308 indicates that the specific product/service is unavailable. Persistence module 308 may transmit a warning/error to PAS 304 indicative of the unavailability and PAS 304 may request a different appeasement offer from ARE 306. In some embodiments, all appeasement offers generated by ARE 306 are sent to PAS 304, which transmits the appeasement offers to persistence module 308 to determine whether any thresholds or safeguards are exceeded.

In some embodiments, persistence module 308 is in communication with PSE 310. Persistence module 308 may transmit the thresholds or comparisons to PSE 310, which may be configured to display on a website or e-commerce platform the appeasement or appeasement offer. In some embodiments, PSE 310 is in communication with one or more electronic devices 312. Electronic devices 312 may include computing device 110, 112, and/or 114 and may include a user interface. In some embodiments, PSE 310 is configured to cause electronic device 312 to display the appeasement offer. For example, the customer may access their order via an e-commerce platform associated with a retailer. The customer may access their order and/or their account via the e-commerce platform using the user interface. Upon accessing the e-commerce platform via electronic device 312, the customer may receive an indication, generated by PSE 310, of the appeasement offer, which is generated by PAS 304. In some embodiments, PSE 310 receives the appeasement offer generated by ARE 306 via persistence module 308. The appeasement offer may be generated by ARE 306 and transmitted to PAS 304, which transmits the appeasement offer to persistence module 308 to determine whether the appeasement offer meets the predetermined criteria for disbursement to the customer (e.g., does not exceed any thresholds or safeguards).

Persistence module 308, once determining that the appeasement offer does not exceed any thresholds, may transmit the appeasement offer to PSE 310 for dispersal to electronic device 312 associated with the customer. PSE 310 may cause a website associated with the e-commerce website and accessed via electronic device 312 to display the appeasement offer in real-time. For example, PSE 310 may cause the website to display the appeasement offer in under a second upon the order data associated with the poor order experience being received by PAS 304.

In some embodiments, appeasement engine 102 is configured to receive order data, generate an appeasement, check the appeasement for safeguards, and cause a user interface accessing the e-commerce platform to display the appeasement in real-time. In real-time may be under one second, under two seconds, under three seconds, under four seconds, under five seconds, or under ten seconds from receipt of the order data to displaying of the appeasement offer on a website accessing the e-commerce platform.

In practice, PAS 304 may receive order data associated with a poor experience (e.g., order delay or cancellation) and associated with a customer via customer ID and transmit the order data to ARE 306. ARE 306 may generate an appeasement offer and transmit the appeasement offer to PAS 304, which transmits the appeasement offer to persistence module 308 for checking against safeguards and thresholds. Persistence module 308, upon determining the appeasement offer does not exceed any thresholds or safeguards, transmits the appeasement offer to PSE 310 for providing to the customer via a website. This may all occur in real-time (e.g., under a second).

In some embodiments, a customer access the appeasement offer on the website to automatically apply the appeasement offer to their account. For example, a customer may receive, in real-time, an appeasement offer that may be already applied to items in their online cart or that can be automatically applied to future orders. For example, the appeasement offer may be free shipping on the customer's next purchase, and that may already be applied to the customer's subsequent order. In another example, the appeasement offer may be an electronic gift card, which may be automatically applied to current items, future items, or added to the customer's wallet (e.g., an online wallet associated with the customer ID of the customer). By way of another example, the appeasement offer may be discounted membership associated with the retailer and may be automatically applied to the account of the customer. The appeasement may be present on the home page of the account or retailer website, on the customer's purchase history, or on a banner on the account page. In some embodiments, the appeasement is provided via a pop-up when the customer accesses the retailer's website.

In some embodiments, PAS 304 receives the appeasement offer from ARE 306 and transmits the appeasement offer to persistence module 308 to check against thresholds and safeguards. Upon determining that the appeasement offer does not run afoul of any thresholds and/or safeguards, persistence module 308 may transmit the appeasement offer (e.g., appeasement offer data) back to PAS 304. PAS 304 may then transmit the appeasement offer to offer engine 314. Offer engine 314 may be configured to generate an offer to be provided to the customer via communication engine 316. For example, offer engine 314 may be configured to generate an appeasement code (e.g., alphanumeric code, image, etc.) that is indicative of the appeasement offer. Offer engine 314 may transmit the appeasement code to communication engine 316, which is configured to generate an electronic mail (“email”) to the customer containing the appeasement code. The customer may then use the appeasement code to apply the appeasement to their account. In some embodiment, communication engine 316, upon receipt of the appeasement code, automatically generates (e.g., without human intervention) an email and sends the email to the customer. The customer may access the appeasement code via the email, which allows the customer to apply the appeasement offer at their discretion. In some embodiments, communication engine 316 is configured to push a notification to electronic device 312 associated with the customer.

As discussed above, PAS 304 and/or ARE 306 may concurrently receive order data and may microbatch the order data to prevent duplicate appeasement offers. In some embodiments, the microbatching occurs in real-time to generate and transmit the appeasement offer to the customer in real-time.

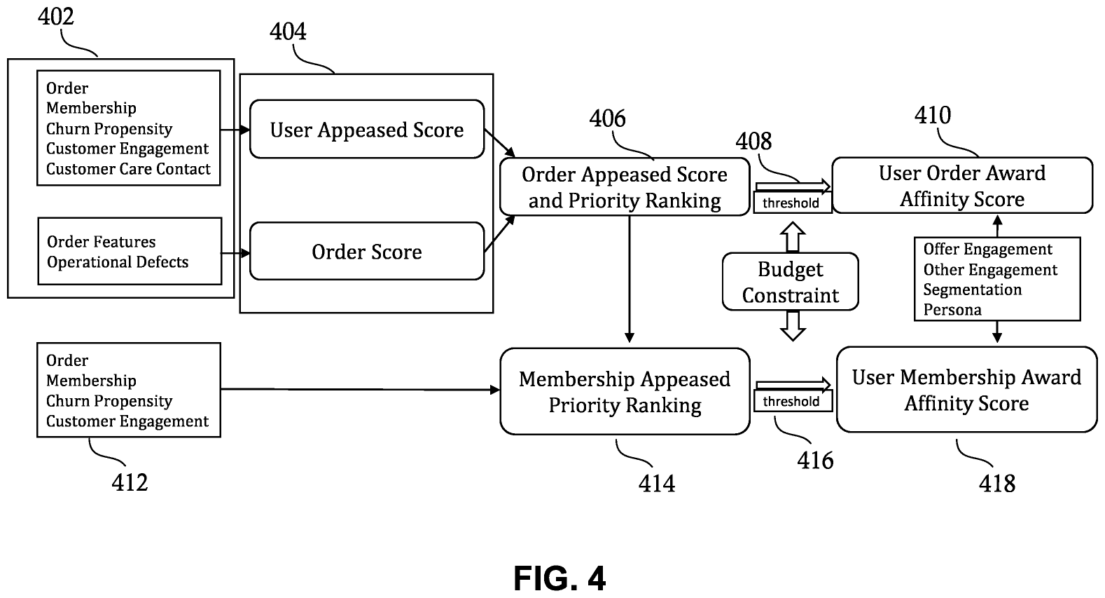

FIG. 4 is a flow diagram of an exemplary model utilized by ARE 306. In some embodiments, ARE 306 determines whether to appease based on issues with an order of a customer of based on a customer's membership associated with the retailer. At operation 402, ARE 306 determines that the customer has had a poor experience associated with their order. ARE 306 may receive customer data including historical data associated with the customer. For example, the customer data may include order data, membership data, churn propensity data, customer engagement data, and customer care contact data. Churn propensity data may indicate how likely a customer is to close their account. Churn propensity data may be determined via one or more models that analyze the customer's historical data. For example, one or more models may be used to determine churn based on factors including length of membership, benefits used by the customer, renewal rate of customer, membership activity, transaction history, and/or demographics. Customer engagement data may include data associated with the customer interacting and engaging with the retailer's website (e.g., via an e-commerce platform). Customer care contact data may include data associated with the customer contacting customer service or representative of the retailer. In some embodiments, ARE 306 receives order data associated with an order that results in a poor experience for the customer. For example, the order data may include features of the order and operational defects that occurred, such as delays, cancellations, delivery issues, billing issues, substitution issues, quality issues, incorrect items, etc.

At operation 404, ARE 306 is configured to generate a user appeased score associated with the user based on the customer data. The user appeased score may measure the customer's affinity towards appeasement. In some embodiments, the user appeased score is dependent and/or associated with order data, membership data, churn propensity data, customer engagement data, and customer care contact data. In some embodiments, ARE 306 generates a user appeased score based on the specific user and order data, membership data, churn propensity data, customer engagement data, and customer care contact data. This allows ARE 306 to generate an appeasement specific to the user. ARE 306 may utilize one or more models to generate the user appeased score by inputting order data, membership data, churn propensity data, customer engagement data, and customer care contact data into the one or models and outputting a user appeased score. In some embodiments, the user appeased score is from 0 to 1, with 1 being a higher affinity towards appeasement.

In some embodiments, ARE 306 is configured to generate an order score. The order score may be associated with a specific order placed by the customer with the retailer. In some embodiments, the higher the order score, the poorer the experience of the customer. For example, a high order score may be indicative of a cancelled order. In contracts, a low order score may be indicative of a perfect order without any issues. The order score may be a measure of the impact of the operational defects felt by the customer as it relates to customer retention. The order score may be dependent on one or more feature variables such as GMV, order size, delayed order, cancelled order, substituted order, wrong order item, poor item quality of order, wrong billing of customer, wrong return address of customer, returning of the items of the order by the customer, request for refund of the order by customer, issues with delivery of the order, or other customer service issues. ARE 306 may utilize one or more models to generate the order score by inputting the one or more feature variables discussed above into the one or more models and outputting the order score. In some embodiments, the order score is from 0 to 1, with 1 being indicative of the order experience having a high negative impact on customer retention (e.g., the customer continuing to shop or be a member of the retailer).

In some embodiments, the order score is based on the below calculations:

$$score = {\sum }_{i = 1}^{n} {w}_{i} * x , {w}_{i} ∈ weight , {x}_{i} ∈ feature variables$$

where xᵢ indicates feature variables and w; indicates weight for the feature variables.

At operation 406, ARE 306 may be configured to combine the user appeased score and the order score to generate an order appeased score. In some embodiments, the order appeased score is from 0 to 1, where a higher score indicates a higher level of appeasement. In some embodiments, ARE 306 compares a plurality of order appeased scores associated with a plurality of customers to determine a priority ranking of appeasements. In some embodiments, ARE 306 groups the appeasements offered into one or more levels. For example, level 1 may be the highest level of appeasement offered and level 3, for example, may be the lowest level of appeasement offered. Level 1 appeasements may include membership extensions, discounted memberships, and promo/discount codes. Level 2 appeasements may include electronic gift cards and cashback. Level 3 appeasements may include free express delivery, one time benefits, and access to limited time offer coupons.

The order appeased score may indicate the level of appeasement offered. In some embodiments, ARE 306 compares the order appeased score to a predetermined threshold to determine if an appeasement should be offered and at what level. An example of various appeasements is shown in Table 1 below.

TABLE 1

| | | Order Appeased | Appeasement |
|---|---|---|---|
| order_id | user_id | Priority Ranking | Qualified For |
| order1 | user_A | 0.98 | Qualified for |
| | | | level 1 appeasement |
| order2 | user_A | 0.65 | Qualified for |
| | | | level 2 appeasement |
| order3 | user_B | 0.87 | Qualified for |
| | | | level 1 appeasement |
| order4 | user_C | 0.33 | Not appeased |

In some embodiments, the order appeased score (e.g., priority ranking) generated by ARE 306 is a weight sum of the user appeased score and the order score. In some embodiments, the order appeased priority ranking is based on the below calculations:

$$Order Appease score = - {w}_{1} log ( 1 - {e}^{( 1 - ( \frac{1}{User Appeased score} ) )} ) - {w}_{2} log ( 1 - {e}^{( 1 - ( \frac{1}{Order score} ) )} )$$

The order appeased score may reflect the relationship between customer satisfaction (e.g., based on the user appeased score) and the efficiency of the order fulfillment process (e.g., the order score). In some embodiments, when the order appeased score and the order score experience a slight increase, their impact on the overall order appeased score is more pronounced. The formulation, structured with an exponential function, embodies the principle that minor fluctuations in the lower tiers of scores yield limited impact on the final score. Conversely, higher values of scores at an individual level can wield substantial influence on the final score. This conceptual framework ensures that the model may be sensitive to meaningful changes in user satisfaction and order efficiency.

At operation 408, ARE 306 may receive from persistence module 308 an indication of whether the customer has received appeasements in the past or within a predetermined time period. In some embodiments, persistence module 308 may provide a budget constraint for appeasements that may be offered to the customer. For example, persistence module 308 may compare one or more appeasement offerings to one or more constraints or thresholds such as budget constraints to determine whether an appeasement can be offered to the customer. In some embodiments, persistence module 308 is configured to transmit a request to ARE 306 to modify or adjust the appeasement offer such that the appeasement offer is within the thresholds or safeguards (e.g., lower discount amount, decreased discount of membership).

At operation 410, ARE 306 may generate a user order award affinity score that is configured to predict the customer's affinity to a specific type of appeasement. The user order award affinity score may be based on historical data associated with the customer. In some embodiments, the user order award affinity score is based on the below function:

User Order Award Affinity Score=f(appeasement_weight, order_appeased_priority_ranking, threshold)

ARE 306 may assign appeasement weights to each appeasement based on the customer's historical data and may use the weights to determine the user order award affinity score. In some embodiments, ARE 306 receives historical data associated with the customer and determines whether a customer has previously received an appeasement offering. For example, ARE 306 may determine that a customer received and redeemed an appeasement and thus that specific appeasement is given more weight. In some embodiments, ARE 306 may determine that a customer has not previously received the appeasement offering and may assign a moderate weight to the appeasement offering for that customer. In some embodiments, ARE 306 may determine that a customer has previously received the appeasement offering, but has not redeemed the appeasement offering and may assign a low weight to the appeasement offering for that customer.

In some embodiments, ARE 306 assigns a weight of 1 to appeasements that have been received and redeemed by the customer, a weight of 0.5 to appeasements that have not been received by the customer, and a weight of 0 to appeasements that have been received by the customer but not redeemed or used. These weights may impact the user order award affinity score for different appeasements and may help ARE 306 determine which appeasements the customer has an affinity for.

The user order award affinity score may indicate an affinity of the customer to specific appeasement offering. In some embodiments, ARE 306 utilizes one or more models to generate the user order award affinity score. For example, ARE 306 may input the order appeased score and/or the order appeased priority ranking into the one or more models to generate the user order award affinity score. The one or more models may include gradient boosted trees that utilizes a multi-class classification task to generate a single appeasement offering for a customer. ARE 306 may generate an affinity of the customer for each type of award. In some embodiments, ARE 306 generates a user order award affinity score for each customer and for each appeasement offering. In alternative embodiments, ARE 306 generates an affinity of the customer for each type of award within a specific level that is based on the order appeased score.

At operation 410, ARE 306 may generate user order award affinity score and based on the user order award affinity score, may determine an appeasement offering. For example, ARE 306 may generate a user order award affinity score for each appeasement offering. This may indicate which appeasement offering the customer has a higher affinity for. ARE 306 may identify the appeasement with the highest affinity score and my recommend that appeasement for delivery to the customer. Table 2 below is an example of recommending appeasements to the customer based on the user order award affinity score of each customer for a plurality of appeasement offerings.

TABLE 2

| | | User Award Affinity | |
|---|---|---|---|
| order_id | user_id | Score | Recommended Award |
| order1 | user_A | {a11:0.38, a12:0.14, | a11 |
| | | a21:0.05, | |
| | | a22:0.22, . . . } | |
| order2 | user_A | {a11:0.38, a12:0.14, | a21 |
| | | a21:0.05, | |
| | | a22:0.02, . . . } | |
| order3 | user_B | {a11:0.18, a12:0.50 | a12 |
| | | a21:0.18, | |
| | | a22:0.09, . . . } | |
| order4 | user_C | {a11:0.38, a12:0.22, | No award |
| | | a21:0.12, | |
| | | a22:0.13, . . . } | |

As shown in Table 2 above, ARE 306 has generated user order award affinity scores for a plurality of orders (order_id) for a plurality of customers (user_id). ARE 306 may determine which appeasement offerings the customer has a high affinity towards and may offer that appeasement to the customer. For example, for order1, user_A has a high affinity for award a11 and for order3, user_B has a high affinity for award a12, thus those are offered to each respective user/customer. In some embodiments, for multiple orders of the same customer that results in a poor experience for the customer, ARE 306 determines that multiple appeasements at different levels. Based on Table 1 above, order2 of user_A is at level 2 based on the order appeased score. Therefore, ARE 306 determines that order2 results in a level 2 appeasement with the highest affinity, which would be reward a21. In some embodiments, ARE 306 determines that an order does not necessitate an appeasement based on the order appeased score and thus does not provide an appeasement. For example, in looking at Table 1, order4 has a low order appeased score and thus does not qualify for an appeasement.

With continued references to FIG. 4, ARE 306 may be configured to generate appeasements based on customers having poor experiences with their membership. For example, a customer may have a membership with a retailer and may have one or more poor experiences with the retailers thereby resulting in the customer desiring to terminate their membership with the retailer. At operation 412, similar to operation 402, ARE 306 determines that the customer has had a poor membership experience. ARE 306 may receive customer data including historical data associated with the customer. For example, the customer data may include order data, membership data, churn propensity data, and customer engagement data. Churn propensity data may indicate how likely a customer is to close their account. Churn propensity data may be determined via one or more models that analyze the customer's historical data. For example, one or more models may be used to determine churn based on factors including length of membership, benefits used by the customer, renewal rate of customer, membership activity, transaction history, and/or demographics. Customer engagement data may include data associated with the customer interacting and engaging with the retailer's website (e.g., via an e-commerce platform).

At operation 414, ARE 306, using one or more models, may generate a membership appeased score similar to the order appeased score. However, at operation 414, ARE 306 may utilize the order appeased score to determine the membership appeased score. At operation 416, similar to operation 408, ARE 306 may receive from persistence module 308 an indication of whether the customer has received appeasements in the past or within a predetermined time period. In some embodiments, persistence module 308 may provide a budget constraint for appeasements that may be offered to the customer. For example, persistence module 308 may compare one or more appeasement offerings to one or more constraints or thresholds such as budget constraints to determine whether an appeasement can be offered to the customer. At operation 418, ARE 306 may generate a user membership award affinity score, similar to how the user award affinity score is generated. In some embodiments, an appeasement of reduced or free membership for a certain amount of time (e.g., one year, two year, six months, etc.) is offered as an appeasement for poor membership experiences.

In some embodiments, ARE 306 utilizes one or more models to generate user order award affinity score. The one or more models may be trained using a training data that includes customer demographics, customer profiles, transactions of customers, purchase history, delivery history, billing history, viewing history, browsing features, and customer interactions with an e-commerce platform of the retailer.

In some embodiments, ARE 306 and/or persistence module 308 may utilize one or more models or algorithms to determine budget constraints for offering appeasements to one or more customers. For example, ARE 306 and/or persistence module 308 may utilize a Knapsack algorithm that assigns weights to each customer according to their order appeasement score and/or order appeasement priority ranking. ARE 306 and/or persistence module 308 may assign a dollar value of predicted award for each customer as values and then given the total budget for appeasement offerings, ARE 306 and/or persistence module 308 may determine which customers get which appeasement offerings while remaining within budget.

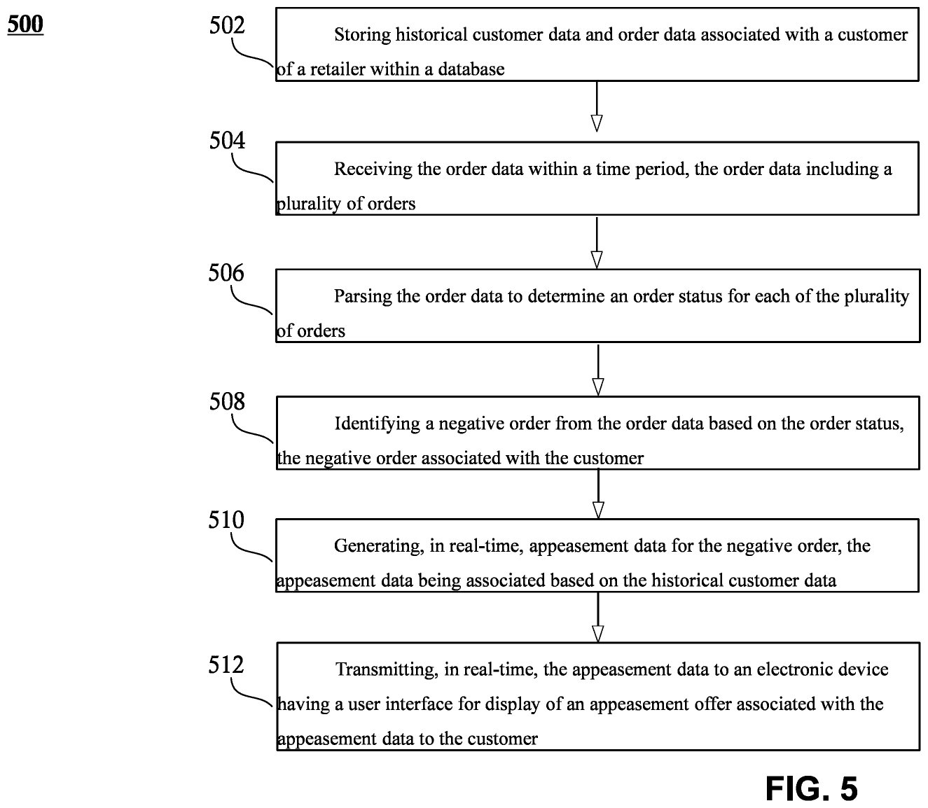

FIG. 5 is a flowchart illustrating an exemplary method for controlling customer retention based on generation of an appeasement offer to the customer. At operation 502, appeasement engine 102 may receive and store historical customer data and orders within a database. The historical customer data and order data may be associated with a specific customer. In some embodiments, appeasement engine 102 is configured to tag the historical customer data and the order data with a customer identifier associated with the customer. Appeasement engine 102 may be configured to map the customer identifier to order data and the historical customer data to link the order data and the historical customer data to the customer. At operation 504, appeasement engine 102 may receive the order data within a time period from the database or one or more other sources. Appeasement engine 102 may receive the order data concurrently from a plurality of sources and may be configured to microbatch the order data received within the time period. In some embodiments, the time period is under one second (e.g., twenty milliseconds). This may prevent generation of appeasement offers for the same order coming from two different sources.

At operation 506, appeasement engine 102 may be configured to parse the order data to determine an order status for each of the plurality of orders. For example, appeasement engine 102 may parse the order data to identify each order within the order data and identify the status of each order, such as whether the order was cancelled, delayed, delivered, substituted, or refunded. At operation 508, appeasement engine 102 may be configured to identify a negative order from the order data based on the order status of each order within the order data. The negative order may be an order that was cancelled, delayed, substituted, or refunded. The negative order may be associated with an order of the customer. At operation 510, appeasement engine 102 may be configured to generate, in real-time, appeasement data for the negative order. In some embodiments, in real-time is upon receipt of the order data and/or identification of the negative order. In real-time may be sub second from identification of the negative order. At operation 512, appeasement engine 102 may be configured to transmit, in real-time, the appeasement data to an electronic device having a user interface for display of an appeasement offer associated with the appeasement data to the customer.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for the purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a database storing historical customer data and order data associated with a customer of a retailer;
a computing device comprising at least one processor in communication with the database, the computing device being configured to:
receive the order data within a time period, the order data including a plurality of orders;
parse the order data to determine an order status for each of the plurality of orders;
identify a negative order from the order data based on the order status, the negative order associated with the customer;
generate, in real-time, appeasement data for the negative order, the appeasement data being associated based on the historical customer data; and
transmit, in real-time, the appeasement data to an electronic device having a user interface for display of an appeasement offer associated with the appeasement data to the customer.

2. The system of claim 1, wherein the computing device is further configured to:
generate, based on the historical customer data, a user appeased score;
generate, based on the order data, an order score;
combine the user appeased score and the order score to generate an order appeased score;
compare the order appeased score to one or more thresholds to generate a comparison;
generate an award affinity score based on the comparison, the award affinity score being associated with an affinity of the customer towards an appeasement type; and
generate, based on the appeasement type, one or more appeasements to be offered to the customer.

3. The system of claim 2, wherein one or more weights are applied to the order score.

4. The system of claim 1, wherein the computing device is further configured to:
compare the appeasement data to one or more thresholds to generate a threshold comparison.

5. The system of claim 4, wherein the computing device is further configured to:
based on the threshold comparison, modify the appeasement data to generate subsequent appeasement data; and
compare the subsequent appeasement data to one or more thresholds to generate a subsequent threshold comparison.

6. The system of claim 1, wherein the computing device is further configured to:
microbatch the plurality of orders within the time period.

7. The system of claim 1, wherein the computing device is further configured to:
train one or more models to generate the appeasement data based on the order data and the historical customer data;
receive redemption data associated with the customer redeeming the appeasement offer associated with the appeasement data; and
refine the one or more models based on the redemption data.

8. The system of claim 1, wherein the computing device is further configured to:
in response to identification of the negative order, generate in real-time, on the user interface of the electronic device, an interactive appeasement display.

9. The system of claim 1, wherein the computing device is further configured to:
in response to identification of the negative order, automatically generate and transmit an electronic correspondence to the electronic device of the customer.

10. The system of claim 1, wherein the order data is received concurrently from a plurality of sources.

11. A computer-implemented method, comprising:
storing historical customer data and order data associated with a customer of a retailer within a database;
receiving the order data within a time period, the order data including a plurality of orders;
parsing the order data to determine an order status for each of the plurality of orders;
identifying a negative order from the order data based on the order status, the negative order associated with the customer;
generating, in real-time, appeasement data for the negative order, the appeasement data being associated based on the historical customer data; and
transmitting, in real-time, the appeasement data to an electronic device having a user interface for display of an appeasement offer associated with the appeasement data to the customer.

12. The method of claim 11 further comprising:
generating, based on the historical customer data, a user appeased score;
generating, based on the order data, an order score;
combining the user appeased score and the order score to generate an order appeased score;
comparing the order appeased score to one or more thresholds to generate a comparison;
generating an award affinity score based on the comparison, the award affinity score being associated with an affinity of the customer towards an appeasement type; and
generating, based on the appeasement type, one or more appeasements to be offered to the customer.

13. The method of claim 12, wherein one or more weights are applied to the order score.

14. The method of claim 11 further comprising:
comparing the appeasement data to one or more thresholds to generate a threshold comparison.

15. The method of claim 14 further comprising:
based on the threshold comparison, modifying the appeasement data to generate subsequent appeasement data; and
comparing the subsequent appeasement data to one or more thresholds to generate a subsequent threshold comparison.

16. The method of claim 11 further comprising:
microbatching the plurality of orders within the time period.

17. The method of claim 11 further comprising:
training one or more models to generate the appeasement data based on the order data and the historical customer data;
receiving redemption data associated with the customer redeeming the appeasement offer associated with the appeasement data; and
refining the one or more models based on the redemption data.

18. The method of claim 11 further comprising:
in response to identification of the negative order, generating in real-time, on the user interface of the electronic device, an interactive appeasement display.

19. The method of claim 11 further comprising:
in response to identification of the negative order, automatically generating and transmitting an electronic correspondence to the electronic device of the customer.

20. A non-transitory computer readable medium having instructions stored thereon, wherein the instructions, when executed by at least one processor, cause at least one device to perform operations comprising:
storing historical customer data and order data associated with a customer of a retailer within a database;
receiving the order data within a time period, the order data including a plurality of orders;
parsing the order data to determine an order status for each of the plurality of orders;
identifying a negative order from the order data based on the order status, the negative order associated with the customer;
generating, in real-time, appeasement data for the negative order, the appeasement data being associated based on the historical customer data; and
transmitting, in real-time, the appeasement data to an electronic device having a user interface for display of an appeasement offer associated with the appeasement data to the customer.
